(19) United States
(12) Patent Application Publication
(10) Pub. No.: US 2022/0360702 A1
(43) Pub. Date: Nov. 10, 2022

(54) IMAGE PROCESSING DEVICE, ELECTRONIC EQUIPMENT, IMAGE PROCESSING METHOD, AND PROGRAM

(71) Applicant: SONY SEMICONDUCTOR SOLUTIONS CORPORATION, KANAGAWA (JP)

(72) Inventors: SHOTARO BABA, KANAGAWA (JP); TAKASHI KUSAKARI, KANAGAWA (JP)

(21) Appl. No.: 17/753,897

(22) PCT Filed: Jul. 29, 2020
(86) PCT No.: PCT/JP2020/029053

§ 371 Date: Mar. 17, 2022

(30) Foreign Application Priority Data
Sep. 26, 2019 (JP) 2019-175291

(51) Int. Cl. H04N 5/235; G01S 17/894

(52) U.S. Cl. CPC H04N 5/2353; H04N 5/2351; G01S 17/894

(57) ABSTRACT

An image processing device includes an image generation unit (212) that generates, in an IR image frame, a first IR image captured in a state in which a pulse wave is on and a second IR image captured in a state in which the pulse wave is off, and an image correction unit (213) that corrects the first IR image on the basis of the second IR image.

### FIELD

The present disclosure relates to an image processing device, electronic equipment, an image processing method, and a program.

### BACKGROUND

A ranging system which is called time of flight (TOF) and in which a distance to an object to be measured is measured on the basis of time from when light is emitted by a light source until when reflected light that is the light reflected by the object to be measured is received by a light receiving unit has been known.

Also, there is a case where an automatic exposure (AE) function is mounted on a TOF sensor in order to receive light with appropriate luminance. By utilization of the AE function, exposure (luminance) is automatically adjusted according to brightness or the like of a shooting scene, and good ranging accuracy can be acquired regardless of the shooting scene.

### CITATION LIST

### Patent Literature

Patent Literature 1: JP 2018-117117 A

### SUMMARY

### Technical Problem

Incidentally, in face authentication using a TOF sensor, it is common to use a confidence image in which accuracy of the image is calculated in four phases. However, since images of four phases are merged and an infrared (IR) image is output, there is a weakness against movement. For example, in a case where there is movement in a subject between the phases, blurring is likely to be generated.

Thus, it is conceivable to generate an IR image with a small number of phases such as one phase or two phases. However, for example, when a fixed pattern noise (FPN) correction is performed, with a dark image prepared in advance, with respect to an image captured in a specific scene such as a case where background light is strong, there is a possibility that desired image quality cannot be acquired due to a mismatch between the captured image and the dark image.

Thus, the present disclosure proposes an image processing device, electronic equipment, an image processing method, and a program capable of appropriately removing an influence of background light.

### Solution to Problem

An image processing device according to an embodiment of the present disclosure includes: an image generation unit that generates, in an IR image frame, a first IR image captured in a state in which a pulse wave is on and a second IR image captured in a state in which the pulse wave is off; and an image correction unit that corrects the first IR image on a basis of the second IR image.

### BRIEF DESCRIPTION OF DRAWINGS

FIG. 1 is a view illustrating an example of a configuration of electronic equipment using a ranging device applicable to an embodiment of the present disclosure.

FIG. 2 is a view for describing a frame configuration.

FIG. 3 is a view for describing a principle of an indirect TOF method.

FIG. 4 is a block diagram illustrating an example of a system configuration of an indirect TOF distance image sensor to which a technology according to the present disclosure is applied.

FIG. 5 is a circuit diagram illustrating an example of a circuit configuration of a pixel in the indirect TOF distance image sensor to which the technology according to the present disclosure is applied.

FIG. 6 is a block diagram illustrating an example of a configuration of an image processing device according to a first embodiment of the present disclosure.

FIG. 7A is a view for describing an image processing method according to an embodiment of the present disclosure.

FIG. 7B is a view for describing the image processing method according to the embodiment of the present disclosure.

FIG. 8A is a view for describing an effect of an FPN correction according to the embodiment of the present disclosure.

FIG. 8B is a view for describing the effect of the FPN correction according to the embodiment of the present disclosure.

FIG. 8C is a view for describing the effect of the FPN correction according to the embodiment of the present disclosure.

FIG. 9A is a view for describing a frame configuration according to the embodiment of the present disclosure.

FIG. 9B is a view for describing a frame configuration according to the embodiment of the present disclosure.

FIG. 10 is a block diagram illustrating an example of a configuration of an image processing device according to a second embodiment of the present disclosure.

FIG. 11 is a view for describing a correction selecting method according to the second embodiment of the present disclosure.

FIG. 12 is a view for describing the correction selecting method according to the second embodiment of the present disclosure.

FIG. 13A is a view for describing an effect of a correction selected by the correction selecting method according to the second embodiment of the present disclosure.

FIG. 13B is a view for describing the effect of the correction selected by the correction selecting method according to the second embodiment of the present disclosure.

FIG. 14A is a view for describing an effect of a correction selected by the correction selecting method according to the second embodiment of the present disclosure.

FIG. 14B is a view for describing the effect of the correction selected by the correction selecting method according to the second embodiment of the present disclosure.

FIG. 15A is a view for describing an effect of a correction selected by the correction selecting method according to the second embodiment of the present disclosure.

FIG. 15B is a view for describing the effect of the correction selected by the correction selecting method according to the second embodiment of the present disclosure.

FIG. 16A is a view for describing an effect of a correction selected by the correction selecting method according to the second embodiment of the present disclosure.

FIG. 16B is a view for describing the effect of the correction selected by the correction selecting method according to the second embodiment of the present disclosure.

FIG. 17 is a flowchart illustrating an example of a flow of processing of the correction selecting method according to the second embodiment of the present disclosure.

FIG. 18A is a view for describing a correction selecting method according to a modification example of the second embodiment of the present disclosure.

FIG. 18B is a view for describing a correction selecting method according to a modification example of the second embodiment of the present disclosure.

### DESCRIPTION OF EMBODIMENTS

In the following, embodiments of the present disclosure will be described in detail on the basis of the drawings. Note that in the following embodiments, overlapped description is omitted by assignment of the same reference sign to identical parts.

The present disclosure will be described in the following order of items.

1. Configuration of electronic equipment

1-1. Frame configuration

1-2. Indirect TOF method

1-3. System configuration of indirect TOF distance image sensor

1-4. Circuit configuration of pixel in indirect TOF distance image sensor

2. First embodiment

2-1. Configuration of image processing device

2-2. Image processing method

2-3. Frame configuration

3. Second embodiment

3-1. Image processing device

3-2. Correction selecting method

3-3. Processing of correction selecting method

4. Modification example of second embodiment

### 1. Configuration of Electronic Equipment

The present disclosure can be suitably applied to a technology of correcting an IR image acquired by photographing an object with a TOF sensor. Thus, first, an indirect TOF method will be described in order to make it easy to understand the present disclosure. The indirect TOF method is a technology of emitting source light (such as laser light in an infrared region) modulated by, for example, pulse width modulation (PWM) to an object, receiving reflected light thereof with a light receiving element, and performing ranging with respect to an object to be measured on the basis of a phase difference in the received reflected light.

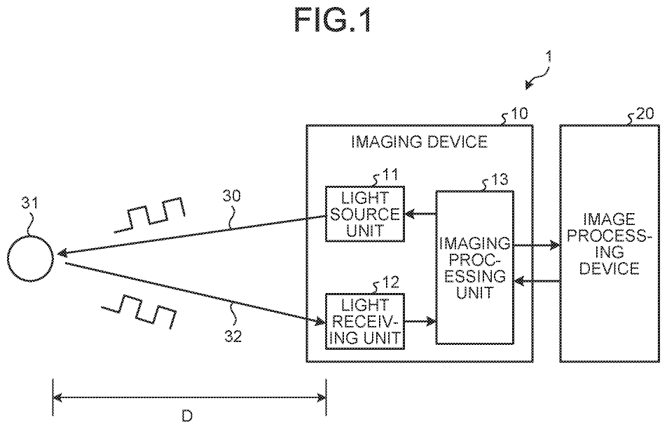

An example of a configuration of electronic equipment according to an embodiment of the present disclosure will be described with reference to FIG. 1. FIG. 1 is a view for describing the example of the configuration of the electronic equipment according to the embodiment of the present disclosure.

As illustrated in FIG. 1, electronic equipment 1 includes an imaging device 10 and an image processing device 20. The image processing device 20 is realized, for example, when a program (such as program according to the present invention) stored in a storage unit (not illustrated) is executed by a central processing unit (CPU), a micro processing unit (MPU), or the like with a random access memory (RAM) or the like as a work area. Also, the image processing device 20 is a controller, and may be realized by an integrated circuit such as an application specific integrated circuit (ASIC) or a field programmable gate array (FPGA), for example. The image processing device 20 requests the imaging device 10 to execute imaging (ranging), and receives an imaging result from the imaging device 10.

The imaging device 10 includes a light source unit 11, a light receiving unit 12, and an imaging processing unit 13.

The light source unit 11 includes, for example, a light emitting element that emits light having a wavelength of an infrared region, and a drive circuit that drives the light emitting element to emit light. The light emitting element can be realized by, for example, a light emitting diode (LED). Note that the light emitting element is not limited to the LED, and may be realized by, for example, a vertical cavity surface emitting laser (VCSEL) in which a plurality of light emitting elements is formed in an array.

The light receiving unit 12 includes, for example, a light receiving element capable of detecting light having the wavelength of the infrared region, and a signal processing circuit that outputs a pixel signal corresponding to the light detected by the light receiving element. The light receiving element can be realized by, for example, a photodiode. Note that the light receiving element is not limited to a photodiode, and may be realized by other elements.

The imaging processing unit 13 executes various kinds of imaging processing, for example, in response to an imaging instruction from the image processing device 20. For example, the imaging processing unit 13 generates a light source control signal to drive the light source unit 11 and performs an output thereof to the light source unit 11.

The imaging processing unit 13 controls light reception by the light receiving unit 12 in synchronization with the light source control signal supplied to the light source unit 11. For example, the imaging processing unit 13 generates an exposure control signal to control exposure time of the light receiving unit 12 in synchronization with the light source control signal, and performs an output thereof to the light receiving unit 12. The light receiving unit 12 performs exposure for an exposure period indicated by the exposure control signal, and outputs a pixel signal to the imaging processing unit 13.

The imaging processing unit 13 calculates distance information on the basis of the pixel signal output from the light receiving unit 12. The imaging processing unit 13 may generate predetermined image information on the basis of this pixel signal. The imaging processing unit 13 outputs the generated distance information and image information to the image processing device 20.

For example, the imaging processing unit 13 generates a light source control signal to drive the light source unit 11 according to an instruction to execute imaging from the image processing device 20, and supplies the light source control signal to the light source unit 11. Here, the imaging processing unit 13 generates a light source control signal, which is modulated by the PWM into a rectangular wave having a predetermined duty, and supplies the light source control signal to the light source unit 11. At the same time, the imaging processing unit 13 controls light reception by the light receiving unit 12 on the basis of an exposure control signal synchronized with the light source control signal.

In the imaging device 10, the light source unit 11 blinks and emits light according to the predetermined duty in response to the light source control signal generated by the imaging processing unit 13. The light emitted from the light source unit 11 is emitted as emission light 30 from the light source unit 11. The emission light 30 is reflected by an object 31 and received by the light receiving unit 12 as reflected light 32, for example. The light receiving unit 12 generates a pixel signal corresponding to the reception of the reflected light 32 and performs an output thereof to the imaging processing unit 13. Note that in practice, the light receiving unit 12 also receives background light (ambient light) of a periphery in addition to the reflected light 32, and the pixel signal includes this background light and a dark component due to the light receiving unit 12 together with a component of the reflected light 32.

Also, in the present embodiment, the imaging device 10 images the object 31 in a state in which the light source unit 11 is off and does not emit light. Then, the light receiving unit 12 receives background light around the object 31. In this case, a pixel signal generated by the light receiving unit 12 includes only the background light and the dark component caused by the light receiving unit 12.

The imaging processing unit 13 executes light reception by the light receiving unit 12 for a plurality of times at different phases. The imaging processing unit 13 calculates a distance D to the object 31 on the basis of a difference between pixel signals due to the light reception at the different phases. The imaging processing unit 13 calculates image information acquired by extraction of the component of the reflected light 32 on the basis of the difference between the pixel signals, and image information including the component of the reflected light 32 and a component of the ambient light. In the following, the image information acquired by extraction of the component of the reflected light 32 on the basis of the difference between the pixel signals is referred to as direct reflected light information, and image information including the component of the reflected light 32 and the component of the ambient light is referred to as RAW image information.

(1-1. Frame Configuration)

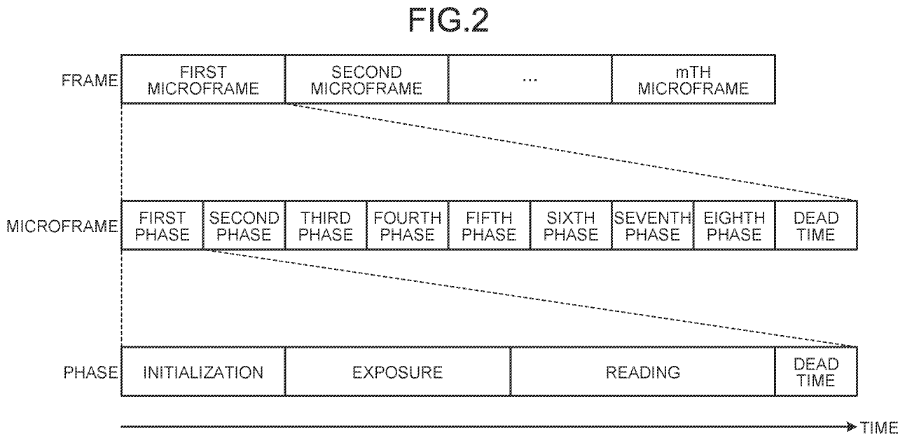

A configuration of a frame used for imaging by the imaging device 10 will be described with reference to FIG. 2. FIG. 2 is a view for describing the frame used for imaging by the imaging device 10.

As illustrated in FIG. 2, the frame includes a plurality of microframes such as a first microframe, a second microframe, . . . , and an mth (m is an integer equal to or larger than 3) microframe. A period of one microframe is a period shorter than a period of one frame of imaging (such as 1/30 seconds). Thus, processing of the plurality of microframes can be executed within one frame period. In addition, a period of each microframe can be set individually.

One microframe includes a plurality of phases such as a first phase, a second phase, a third phase, a fourth phase, a fifth phase, a sixth phase, a seventh phase, and an eighth phase. One microframe can include eight phases at a maximum. Thus, processing of the plurality of phases can be executed within one microframe period. Note that a dead time period is provided at the end of each microframe in order to prevent interference with processing of a next microframe.

In the present embodiment, an object can be imaged in one phase. As illustrated in FIG. 2, initialization processing, exposure processing, and reading processing can be executed in one phase. In other words, the RAW image information can be generated in one phase. Thus, in the present embodiment, a plurality of pieces of RAW image information can be generated in one microframe. For example, RAW image information acquired by imaging of the object 31 in a state in which the light source unit 11 is on, and RAW image information acquired by imaging of the object 31 in a state in which the light source unit 11 is off can be generated in one microframe. Note that a dead time period for adjusting a frame rate is provided at the end of each phase.

(1-2. Indirect TOF Method)

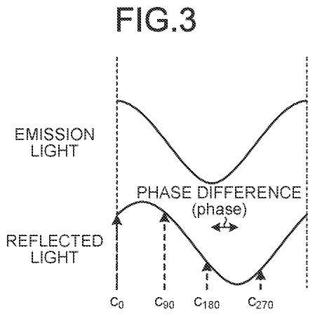

A principle of the indirect TOF method will be described with reference to FIG. 3. FIG. 3 is a view for describing the principle of the indirect TOF method.

In FIG. 3, light modulated by a sine wave is used as the emission light 30 emitted from the light source unit 11. Ideally, the reflected light 32 becomes a sine wave having a phase difference corresponding to a distance D with respect to the emission light 30.

The imaging processing unit 13 performs a plurality of times of sampling with respect to a pixel signal of received reflected light 32 at different phases, and acquires a light quantity value indicating a light quantity each time of the sampling. In the example of FIG. 3, light quantity values C₀, C₉₀, C₁₈₀, and C₂₇₀ are respectively acquired in phases that are a phase of 0°, a phase of 90°, a phase of 180°, and a phase of 270° with respect to the emission light 30. In the indirect TOF method, distance information is calculated on the basis of a difference in light quantity values of a pair having a phase difference of 180° among the phases of 0°, 90°, 180°, and 270°.

(1-3. System Configuration of Indirect TOF Distance Image Sensor)

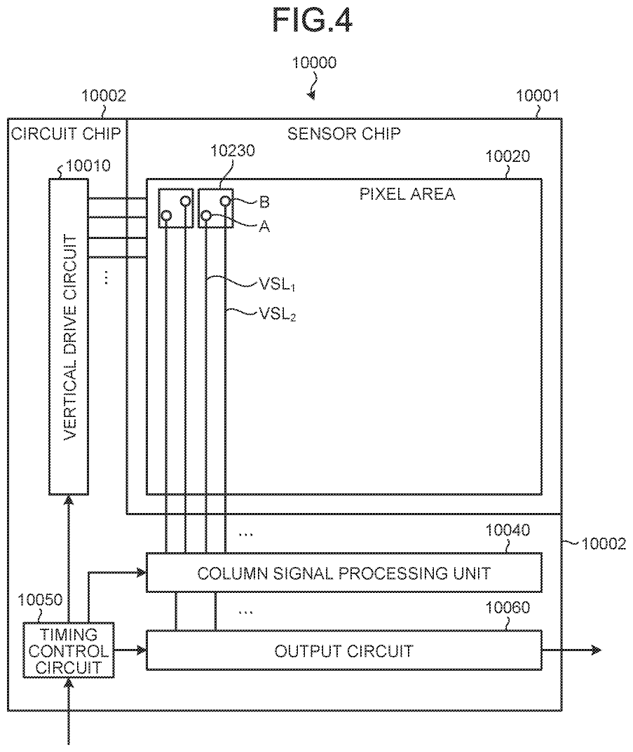

An example of a system configuration of an indirect TOF image sensor according to the present disclosure will be described with reference to FIG. 4. FIG. 4 is a block diagram illustrating an example of the system configuration of the indirect TOF distance image sensor according to the present disclosure.

As illustrated in FIG. 4, an indirect TOF distance image sensor 10000 has a stacked structure including a sensor chip 10001, and a circuit chip 10002 stacked on the sensor chip 10001. In this stacked structure, the sensor chip 10001 and the circuit chip 10002 are electrically connected through a connection portion (not illustrated) such as a via or a Cu—Cu connection. Note that a state in which a wiring line of the sensor chip 10001 and a wiring line of the circuit chip 10002 are electrically connected via the above-described connection portion is illustrated in FIG. 4.

A pixel array portion 10020 is formed on the sensor chip 10001. The pixel array portion 10020 includes a plurality of pixels 10230 arranged in a matrix (array) in a two-dimensional grid pattern on the sensor chip 10001. In the pixel array portion 10020, each of the plurality of pixels 10230 receives infrared light, performs photoelectric conversion, and outputs an analog pixel signal. In the pixel array portion 10020, two vertical signal lines VSL₁ and VSL₂ are wired for each pixel column. When it is assumed that the number of pixel columns in the pixel array portion 10020 is M (M is an integer), 2×M vertical signal lines VSL are wired in total on the pixel array portion 10020.

Each of the plurality of pixels 10230 has two taps A and B (details thereof will be described later). In the two vertical signal lines VSL₁ and VSL₂, a pixel signal AIN_{P1} based on a charge of a tap A of a pixel 10230 in a corresponding pixel column is output to the vertical signal line VSL₁, and a pixel signal AIN_{P2} based on a charge of a tap B of the pixel 10230 in the corresponding pixel column is output to the vertical signal line VSL₂. The pixel signals AIN_{P1} and AIN_{P2} will be described later.

A vertical drive circuit 10010, a column signal processing unit 10040, an output circuit unit 10060, and a timing control unit 10050 are arranged on the circuit chip 10002. The vertical drive circuit 10010 drives each pixel 10230 of the pixel array portion 10020 in a unit of a pixel row and causes the pixel signals AIN_{P1} and AIN_{P2} to be output. Under the driving by the vertical drive circuit 10010, the pixel signals AIN_{P1} and AIN_{P2} output from the pixels 10230 in the selected row are supplied to the column signal processing unit 10040 through the vertical signal lines VSL₁ and VSL₂.

The column signal processing unit 10040 has a configuration including, in a manner corresponding to the pixel columns of the pixel array portion 10020, a plurality of ADCs (corresponding to column AD circuit described above) respectively provided for the pixel columns, for example. Each ADC performs AD conversion processing on the pixel signals AIN_{P1} and AIN_{P2} supplied through the vertical signal lines VSL₁ and VSL₂, and performs an output thereof to the output circuit unit 10060. The output circuit unit 10060 executes CDS processing or the like on the digitized pixel signals AIN_{P1} and AIN_{P2} output from the column signal processing unit 10040, and performs an output thereof to the outside of the circuit chip 10002.

The timing control unit 10050 generates various timing signals, clock signals, control signals, and the like. Drive control of the vertical drive circuit 10010, the column signal processing unit 10040, the output circuit unit 10060, and the like is performed on the basis of these signals.

(1-4. Circuit Configuration of Pixel in Indirect TOF Distance Image Sensor)

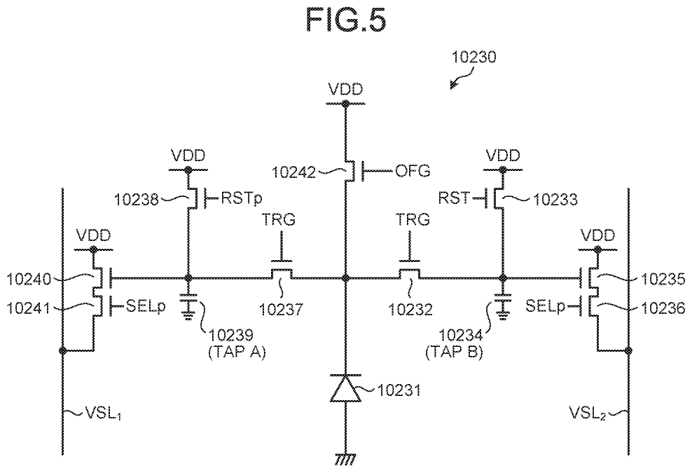

FIG. 5 is a circuit diagram illustrating an example of a circuit configuration of a pixel in the indirect TOF distance image sensor to which the technology according to the present disclosure is applied.

A pixel 10230 according to the present example includes, for example, a photodiode 10231 as a photoelectric conversion unit. In addition to the photodiode 10231, the pixel 10230 includes an overflow transistor 10242, two transfer transistors 10232 and 10237, two reset transistors 10233 and 10238, two floating diffusion layers 10234 and 10239, two amplifier transistors 10235 and 10240, and two selection transistors 10236 and 10241. The two floating diffusion layers 10234 and 10239 correspond to the taps A and B illustrated in FIG. 4.

The photodiode 10231 photoelectrically converts received light and generates a charge. The photodiode 10231 can have a back-illuminated pixel structure. The back-illuminated structure is as described in the pixel structure of the CMOS image sensor. However, the back-illuminated structure is not a limitation, and a front-illuminated structure in which light emitted from a side of a front surface of a substrate is captured may be employed.

The overflow transistor 10242 is connected between a cathode electrode of the photodiode 10231 and a power-supply line of a power supply voltage VDD, and has a function of resetting the photodiode 10231. Specifically, the overflow transistor 10242 sequentially discharges the charge of the photodiode 10231 to the power-supply line by turning into a conduction state in response to an overflow gate signal OFG supplied from the vertical drive circuit 10010.

The two transfer transistors 10232 and 10237 are connected between the cathode electrode of the photodiode 10231 and the two floating diffusion layers 10234 and 10239, respectively. Then, the transfer transistors 10232 and 10237 sequentially transfer the charges generated in the photodiode 10231 to the floating diffusion layers 10234 and 10239 respectively by turning into the conduction state in response to a transfer signal TRG supplied from the vertical drive circuit 10010.

The floating diffusion layers 10234 and 10239 corresponding to the taps A and B accumulate the charges transferred from the photodiode 10231, convert the charges into voltage signals having voltage values corresponding to the charge amounts, and generate the pixel signals AIN_{P1} and AIN_{P2}.

The two reset transistors 10233 and 10238 are connected between the power-supply line of the power supply voltage VDD and the two floating diffusion layers 10234 and 10239, respectively. Then, by turning into the conduction state in response to a reset signal RST supplied from the vertical drive circuit 10010, the reset transistors 10233 and 10238 respectively extract the charges from the floating diffusion layers 10234 and 10239 and initialize the charge amounts.

The two amplifier transistors 10235 and 10240 are respectively connected between the power-supply line of the power supply voltage VDD and the two selection transistors 10236 and 10241, and respectively amplify the voltage signals on which charge-voltage conversion is respectively performed in the floating diffusion layers 10234 and 10239.

The two selection transistors 10236 and 10241 are connected between the two amplifier transistors 10235 and 10240 and the vertical signal lines VSL₁ and VSL₂, respectively. Then, by turning into the conduction state in response to a selection signal SEL supplied from the vertical drive circuit 10010, the selection transistors 10236 and 10241 respectively output the voltage signals respectively amplified in the amplifier transistors 10235 and 10240 to the two vertical signal lines VSL₁ and VSL₂ as the pixel signals AIN_{P1} and AIN_{P2}.

The two vertical signal lines VSL₁ and VSL₂ are connected, for each pixel column, to an input end of one ADC in the column signal processing unit 10040, and transmit the pixel signals AIN_{P1} and AIN_{P2} output from the pixels 10230 in each pixel column to the ADC.

Note that the circuit configuration of the pixel 10230 is not limited to the circuit configuration illustrated in FIG. 4 as long as the pixel signals AIN_{P1} and AIN_{P2} can be generated by photoelectric conversion in the circuit configuration.

### 2. First Embodiment

(2-1. Image Processing Device)

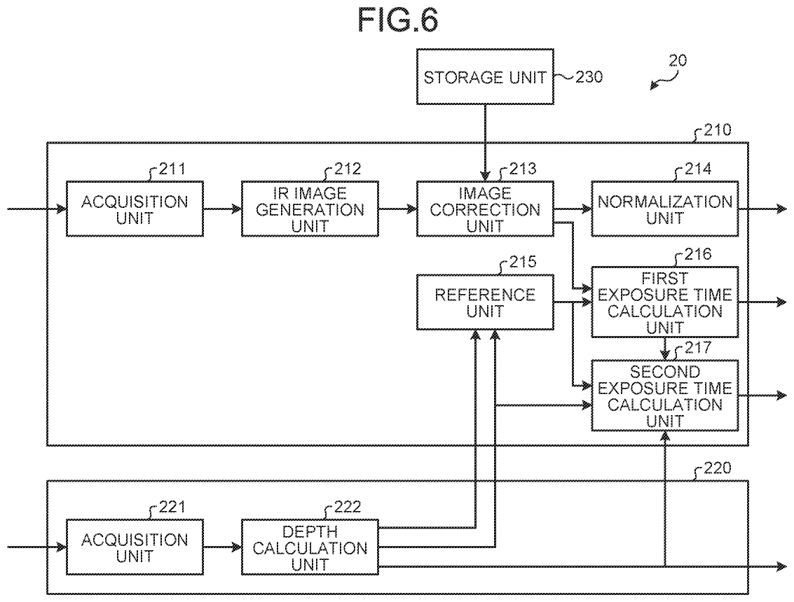

A configuration of an image processing device 20 according to the first embodiment of the present disclosure will be described with reference to FIG. 6. FIG. 6 is a block diagram illustrating an example of the configuration of the image processing device 20 according to the first embodiment of the present disclosure.

As illustrated in FIG. 6, the image processing device 20 includes an IR image processing device 210, a depth image processing device 220, and a storage unit 230.

The IR image processing device 210 executes processing of correcting an IR image, and the like. The depth image processing device 220 executes processing of calculating depth, and the like. The IR image processing device 210 and the depth image processing device 220 execute processing in parallel.

The storage unit 230 stores various kinds of information. The storage unit 230 stores, for example, a dark image to correct an IR image. The storage unit 230 is realized by a semiconductor memory element such as a random access memory (RAM) or a flash memory, or a storage device such as a hard disk or an optical disk, for example.

The IR image processing device 210 includes an acquisition unit 211, an IR image generation unit 212, an image correction unit 213, a normalization unit 214, a reference unit 215, a first exposure time calculation unit 216, and a second exposure time calculation unit 217.

The acquisition unit 211 acquires various kinds of information from an imaging device 10. The acquisition unit 211 acquires, for example, RAW image information related to an object imaged by the imaging device 10. For example, the acquisition unit 211 selectively acquires RAW image information of each phase included in a microframe. For example, in order to correct an IR image, the acquisition unit 211 acquires RAW image information related to the object imaged in a state in which a light source unit 11 is on, and RAW image information related to an object portion imaged in a state in which the light source unit 11 is off. The acquisition unit 211 outputs the acquired RAW image information to the IR image generation unit 212.

The IR image generation unit 212 generates an IR image on the basis of the RAW image information received from the acquisition unit 211. For example, the IR image generation unit 212 may generate an IR image resolution of which is converted into what is suitable for face authentication. The IR image generation unit 212 outputs the generated IR image to the image correction unit 213.

The image correction unit 213 executes various kinds of correction processing on the IR image received from the IR image generation unit 212. The image correction unit 213 executes correction processing in such a manner that the IR image becomes suitable for face authentication of a person included therein. For example, on the basis of the dark image stored in the storage unit 230, the image correction unit 213 executes an FPN correction on the IR image received from the IR image generation unit 212. For example, on the basis of an IR image related to the object imaged in a state in which the light source unit 11 is off (hereinafter, also referred to as light-source-off image), the image correction unit 213 executes the FPN correction on an IR image related to the object imaged in a state in which the light source unit 11 is on.

(2-2. Image Processing Method)

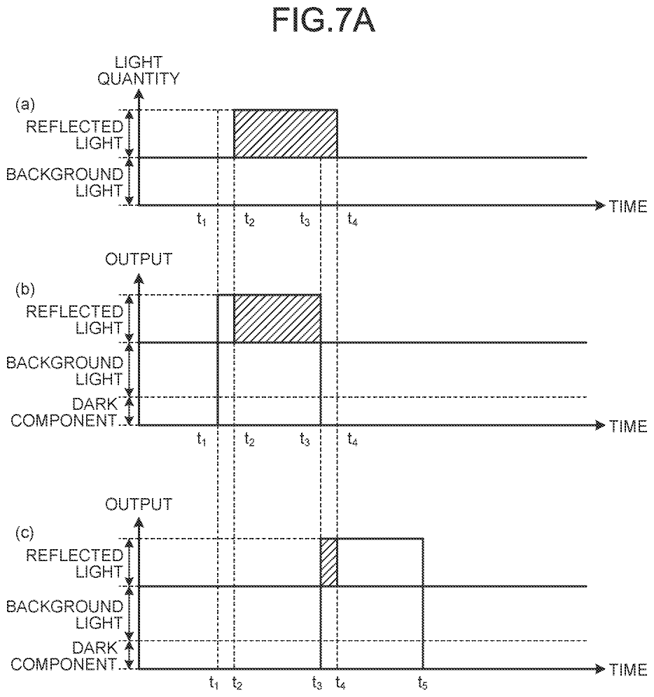

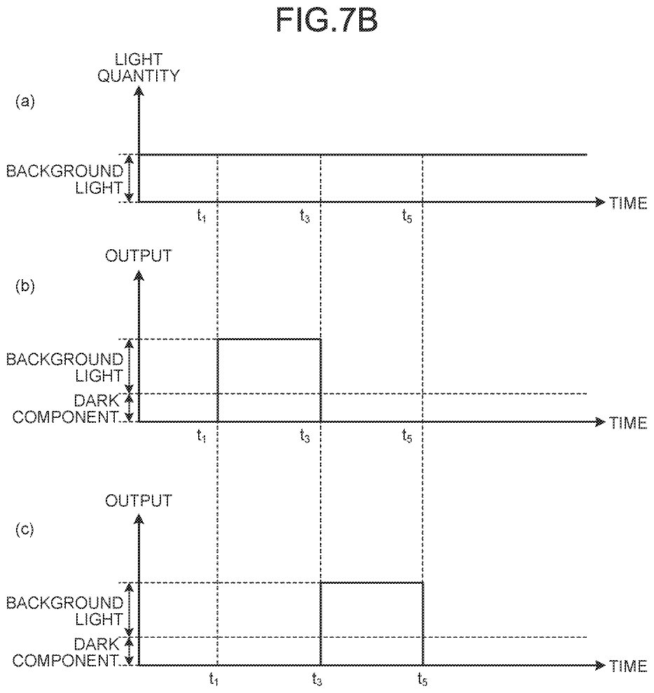

A principle of a method of executing the FPN correction on the basis of pieces of RAW image information captured in a state in which the light source is on and in a state in which the light source is off will be described with reference to FIG. 7A and FIG. 7B. FIG. 7A is a view illustrating a quantity of light received by a light receiving unit, an output value of a pixel signal output from the tap A, and an output value of a pixel signal output from the tap B in a case where an object is imaged in a state in which the light source is on. FIG. 7B is a view illustrating the quantity of light received by the light receiving unit, an output value of the pixel signal output from the tap A, and an output value of the pixel signal output from the tap B in a case where the object is imaged in a state in which the light source is off.

FIG. 7A(a) is a view illustrating the quantity of light received by the light receiving unit 12, FIG. 7A(b) is a view illustrating the output value of the pixel signal from the tap A, and FIG. 7A(c) is a view illustrating the output value of the pixel signal from the tap B.

An example illustrated in FIG. 7A(a) to FIG. 7A(c) indicate that imaging is started at a time point of t1, light reception by the light receiving unit 12 and an output from the tap A are started at a time point of t2, and the output from the tap A is ended and an output from the tap B is started at a time point of t3. In addition, it is indicated that the light reception by the light receiving unit 12 is ended at a time point of t4 and the output from the tap B is ended at a time point of t5. In FIG. 7A(a) to FIG. 7A(c), components of reflected light are indicated by hatching.

In the example illustrated in FIG. 7A(a) to FIG. 7(c), values of a pixel signal A output from the tap A and a pixel signal B output from the tap B can be expressed as follows.

A=G_{A}(S+Amb)+D_{A} (1)

B=G_{B}(P−S+Amb)+D_{B} (2)

In the expression (1) and the expression (2), G_{A} represents a gain value of the tap A, G_{B} represents a gain value of the tap B, P represents reflected light, S represents a light quantity of the reflected light received by the tap A, Amb represents background light, D_{A} represents a dark component of the tap A, and D_{B} represents a dark component of the tap B.

That is, the output value from the tap A includes the background light and the dark component of the tap A in addition to the reflected light from the object. Similarly, the output value from the tap B includes the background light and the dark component of the tap B in addition to the reflected light from the object. The imaging device 10 outputs the sum of the pixel signal A and the pixel signal B as RAW image information to the image processing device 20. Thus, the RAW image information output from the imaging device 10 to the image processing device 20 includes an influence of the background light, the dark component of the tap A, and the dark component of the tap B. Thus, it is desirable to remove the influence of the background light, the dark component of the tap A, and the dark component of the tap B in order to accurately perform recognition processing such as face authentication.

FIG. 7B(a) is a view illustrating the quantity of light received by the light receiving unit 12, FIG. 7B(b) is a view illustrating the output value of the pixel signal from the tap A, and FIG. 7B(c) is a view illustrating the output value of the pixel signal from the tap B.

As illustrated in FIG. 7B(a), the light receiving unit 12 receives only the background light since the light source unit 11 is in a state of being off. When the imaging device 10 images the object in such a situation, the tap A outputs a pixel signal A_{Off} including only the background light and the dark component. Similarly, the tap B outputs a pixel signal B_{Off} including only the background light and the dark component. Values of the pixel signal A_{Off} and the pixel signal B_{Off} at this time can be expressed as follows.

A_{Off}=G_{A}(Amb_{Off})+D_{AOff} (3)

B_{Off}=G_{B}(Amb_{Off})+D_{BOff} (4)

In the expression (3) and the expression (4), Amb_{Off}is the background light of when the light source unit 11 is in the off state, D_{AOff} is the dark component of the tap A of when the light source unit 11 is in the off state, and D_{BOff} is the dark component of the tap B of when the light source unit 11 is in the off state. Since the background light and the dark component do not change regardless of whether the state of the light source unit 11 is the on state or the off state, the following relationships hold.

Amb_{Off}=Amb (5)

D_{AOff}=D_{A} (6)

D_{BOff}=D_{B} (7)

Substituting the expression (5) to the expression (7) into the expression (3) and subtracting the expression (3) from the expression (1) give the following relationship.

A−A_{Off}=SG_{A} (8)

Substituting the expression (5) to the expression (7) into the expression (4) and subtracting the expression (4) from the expression (2) give the following relationship.

B−B_{OFF}=SG_{B} (9)

Then, the following relationship is acquired by calculation of the expression (8) and the expression (9).

(A−A_{Off})+(B−B_{Off})=S(G_{A}+G_{B}) (10)

As described above, the image correction unit 213 can remove the influence of the background light and the dark component on the basis of the pieces of RAW image information captured in a state in which the light source is on and a state in which the light source is off.

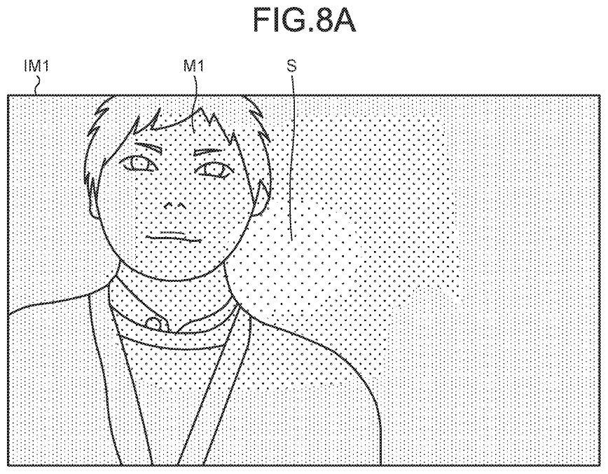

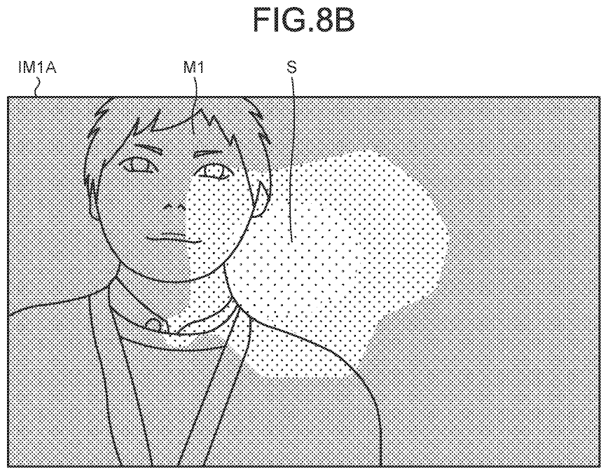

An effect of the FPN correction according to the embodiment of the present disclosure will be described with reference to FIG. 8A, FIG. 8B, and FIG. 8C. FIG. 8A to FIG. 8C are views for describing an effect of the FPN correction according to the embodiment of the present disclosure.

FIG. 8A is a view illustrating an IR image IM1 before the correction which image is generated on the basis of the pixel signal from the tap A and the pixel signal from the tap B. The IR image IM1 includes a person M1 and the sun S. In the IR image IM1, an entire face of the person M1 is blurred due to an influence of sunlight. Thus, even when face authentication processing of a person M is executed on the basis of the IR image IM1, desired recognition accuracy cannot be acquired. Note that the IR image IM1 is an IR image captured in a state in which the light source unit 11 is on.

FIG. 8B is a view illustrating an IR image IM1A acquired by application of a conventional FPM correction to the IR image IM1 illustrated in FIG. 8A. For example, the image correction unit 213 can acquire the IR image IM1A by executing the FPN correction on the IR image IM1 on the basis of a dark image stored in advance in the storage unit 230. However, also in the IR image IM1A, it is difficult to recognize the face of the person M1 due to the influence of the sun S. As described above, for example, in an environment with strong light such as sunlight, there is a case where a mismatch with the dark image is generated and a desired IR image cannot be acquired even when the FPN correction is performed.

FIG. 8C is a view illustrating an IR image IM1B acquired by application of the FPN correction according to the embodiment of the present disclosure to the IR image IM1 illustrated in FIG. 8A. That is, the image correction unit 213 executes the FPN correction on the IR image IM1, which is captured in a state in which the light source unit 11 is on, on the basis of a light-source-off image corresponding to the IR image IM1. The IR image IM1 and the light-source-off image corresponding to the IR image IM1 are respectively captured in successive phases in the same microframe. Since an influence of the reflected light is not included, the light-source-off image corresponding to the IR image IM1 is an IR image including only the sun S. Thus, it is possible to remove the influence of the sun S from the IR image IM1 by using the light-source-off image corresponding to the IR image IM1. Thus, the face of the person M1 can be clearly recognized in the IR image IM1B. As a result, a recognition rate in the face authentication of the person M is improved.

FIG. 6 will be referred to again. The image correction unit 213 outputs the corrected IR image to the normalization unit 214 and the first exposure time calculation unit 216. Specifically, the image correction unit 213 outputs at least one of a correction result based on the dark image or a correction result based on the light-source-off image corresponding to the IR image IM1 to the normalization unit 214 and the first exposure time calculation unit 216.

The normalization unit 214 normalizes the IR image received from the image correction unit 213. The normalization unit 214 outputs the normalized IR image to the outside. As a result, an IR image suitable for the face recognition processing is provided to the user.

The reference unit 215 receives, for example, depth calculated by a depth calculation unit 222. For example, the reference unit 215 receives accuracy of the depth. The reference unit 215 generates a mask image on the basis of the depth and the accuracy of the depth. Here, the mask image is, for example, an image acquired by masking of a subject other than the object included in a depth image. The reference unit 215 outputs the generated mask image to the first exposure time calculation unit 216 and the second exposure time calculation unit 217.

On the basis of the corrected IR image received from the image correction unit 213 and the mask image received from the reference unit 215, the first exposure time calculation unit 216 calculates exposure time in imaging to generate an IR image. As a result, optimal exposure time for generating the IR image is calculated.

On the basis of the mask image received from the reference unit 215 and the accuracy of the depth received from the depth calculation unit 222, the second exposure time calculation unit 217 calculates the exposure time in imaging to calculate the depth.

The depth image processing device 220 includes an acquisition unit 221 and the depth calculation unit 222.

The acquisition unit 221 acquires various kinds of information from the imaging device 10. The acquisition unit 221 acquires, for example, RAW image information related to the object imaged by the imaging device 10. For example, the acquisition unit 221 selectively acquires RAW image information of each phase included in a microframe. For example, the acquisition unit 221 acquires RAW image information of four phases which information is captured at phases of 0°, 90°, 180°, and 270° in order to generate a depth image. The acquisition unit 221 outputs the acquired RAW image information to the depth calculation unit 222.

For example, the depth calculation unit 222 calculates depth on the basis of the RAW image information of the four phases which information is received from the acquisition unit 221. The depth calculation unit 222 calculates, for example, accuracy on the basis of the calculated depth. For example, the depth calculation unit 222 may generate the depth image on the basis of the calculated depth. The depth calculation unit 222 outputs the calculated depth to the outside. As a result, distance information to the object can be acquired. Also, the depth calculation unit 222 outputs the calculated depth and accuracy to the reference unit 215.

(2-3. Frame Configuration)

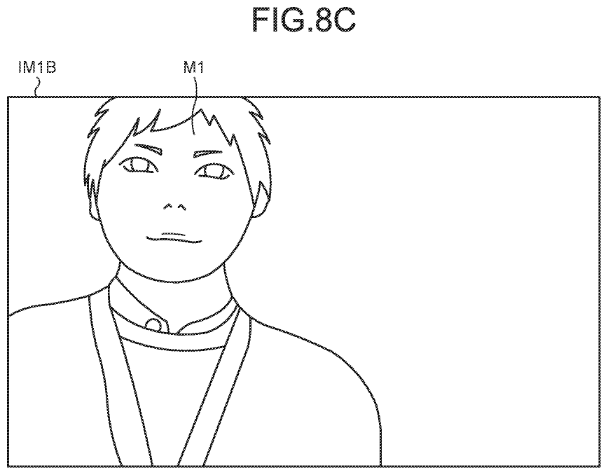

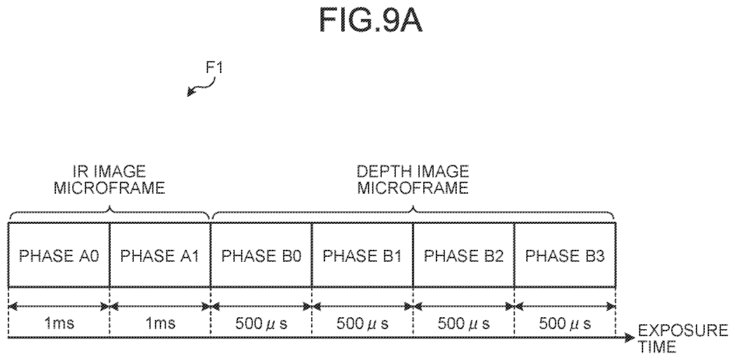

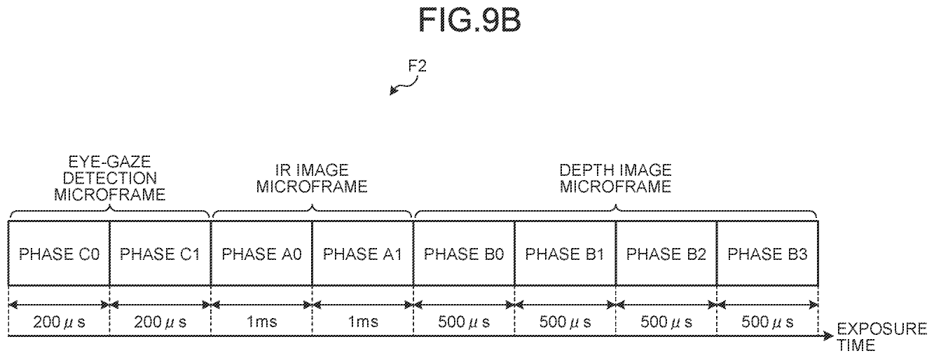

A frame configuration used for imaging according to the embodiment of the present disclosure will be described with reference to FIG. 9A and FIG. 9B. FIG. 9A and FIG. 9B are views for describing the frame configuration used for the imaging according to the embodiment of the present disclosure.

As illustrated in FIG. 9A, a frame F1 according to the embodiment of the present disclosure includes an IR image microframe and a depth image microframe.

The IR image microframe includes, for example, two phases that are a phase A0 and a phase A1. The phase A0 is, for example, a phase in which the object is imaged in a state in which the light source unit 11 is off. The phase A1 is, for example, a phase in which the object is imaged in a state in which the light source unit 11 is on.

The depth image microframe includes, for example, four phases that are a phase B0, a phase B1, a phase B2, and a phase B3. The phase B0 is, for example, a phase in which the object is imaged when a phase difference between emission light to the object and reflected light from the object is 0°. The phase B1 is, for example, a phase in which the object is imaged when the phase difference between the emission light to the object and the reflected light from the object is 90°. The phase B2 is, for example, a phase in which the object is imaged when the phase difference between the emission light to the object and the reflected light from the object is 180°. The phase B3 is, for example, a phase in which the object is imaged when the phase difference between the emission light to the object and the reflected light from the object is 270°.

In the frame F1, exposure time in the IR image microframe and the depth image microframe can be individually adjusted (automatic exposure (AE)). For example, the exposure time may be adjusted to be long in the IR image microframe in order to secure brightness, and the exposure time may be adjusted to be short in the depth image microframe in order to control power consumption. In this case, the exposure time in each of the phase A0 and the phase A1 of the IR image microframe may be adjusted to 1 ms, for example. Also, the exposure time in each of the phase B0, the phase B1, the phase B2, and the phase B3 of the depth image microframe may be adjusted to 500 μs, for example. Note that the exposure time in each phase is not limited to these.

As illustrated in FIG. 9B, a frame F2 according to the embodiment of the present disclosure may include an eye-gaze detection microframe in addition to the IR image microframe and the depth image microframe. In the following, since conditions of the IR image microframe and the depth image microframe are similar to the conditions illustrated in FIG. 9A, a description thereof is omitted.

The eye-gaze detection microframe includes, for example, two phases that are a phase C0 and a phase C1. The phase C0 is, for example, a phase in which the object is imaged in a state in which the light source unit 11 is off. The phase C1 is, for example, a phase in which the object is imaged in a state in which the light source unit 11 is on.

In the frame F2, exposure time in the IR image microframe, the depth image microframe, and the eye-gaze detection microframe can be individually adjusted. For example, in a case where a person to be photographed wears glasses, there is a case where light is reflected by the glasses and an eye-gaze cannot be detected when eye-gaze detection necessary for face authentication is performed. Thus, in the eye-gaze detection microframe, the exposure time may be adjusted to be shorter than those of the IR image microframe and the depth image microframe in such a manner that light is not reflected by the glasses. For example, the exposure time in each of the phase C0 and the phase C1 of the eye-gaze detection microframe may be adjusted to, for example, 200 μs. Note that the exposure time in each of the phase C0 and the phase C1 is not limited to this.

As described above, in the first embodiment, an IR image captured in the environment with strong background light such as the sun is corrected on the basis of an IR image captured in a state in which the light source is off, whereby an influence of the sun can be removed. As a result, the recognition accuracy of the face authentication using the IR image captured by the TOF, or the like can be improved.

### 3. Second Embodiment

Correction method selection processing according to the second embodiment of the present disclosure will be described.

As described above, when face authentication is performed by utilization of an IR image including strong light such as sunlight, it is possible to remove an influence of the sunlight by using a light-source-off image instead of a dark image. Thus, a recognition rate can be improved. However, for example, when the IR image is corrected by utilization of the light-source-off image in a situation such as the interior in which situation there is a small quantity of ambient light, there is a possibility that a contrast of the image becomes small and the recognition rate is decreased. Thus, it is preferable to perform switching between a correction using the dark image and a correction using the light-source-off image according to intensity of background light.

(3-1. Image Processing Device)

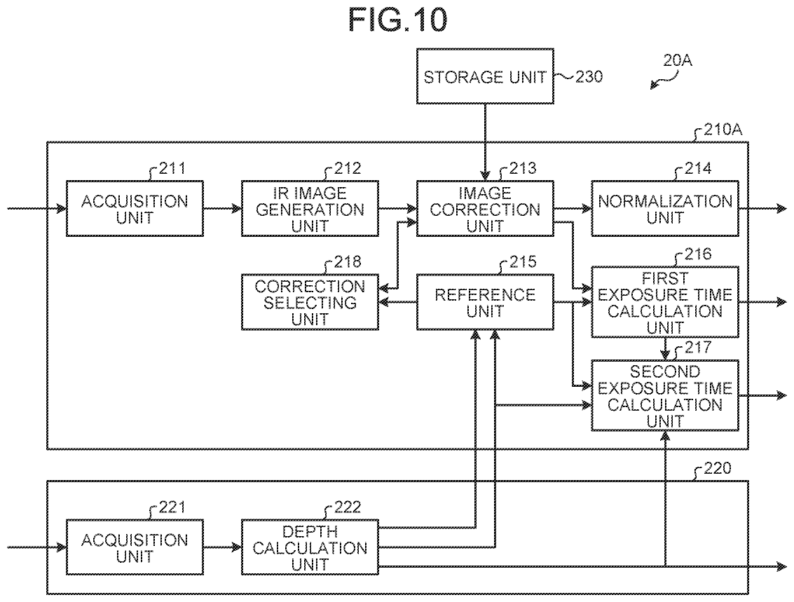

A configuration of an image processing device according to the second embodiment of the present disclosure will be described with reference to FIG. 10. FIG. 10 is a block diagram illustrating the configuration of the image processing device according to the second embodiment of the present disclosure.

As illustrated in FIG. 10, an image processing device 20A is different from the image processing device 20 illustrated in FIG. 6 in a point that an IR image processing device 210A includes a correction selecting unit 218.

The correction selecting unit 218 selects a method of a correction with respect to an IR image. The correction selecting unit 218 receives information related to depth from a reference unit 215, for example. For example, the correction selecting unit 218 receives, from an image correction unit 213, an IR image corrected on the basis of a light-source-off image. The correction selecting unit 218 selects a correction method on the basis of the IR image received from the image correction unit 213 and the information that is related to the depth and received from the reference unit 215.

(3-2. Correction Selecting Method)

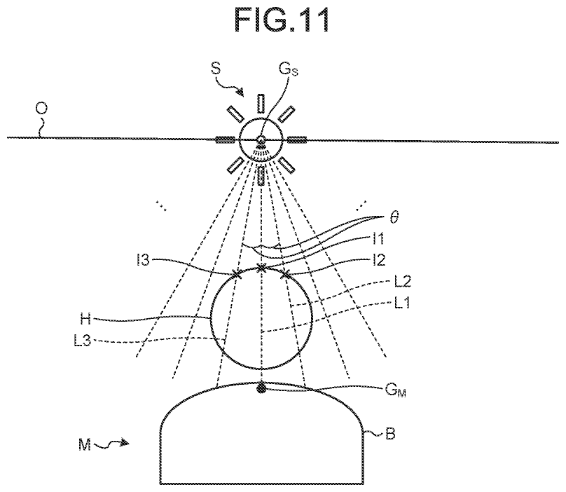

The correction selecting method will be described with reference to FIG. 11. FIG. 11 is a view for describing the correction selecting method. In FIG. 11, a situation in which the sun S is located above a head of a person M is assumed.

For example, the correction selecting unit 218 extracts outlines of a head portion H and a body portion B of the person M on the basis of the information that is related to the depth and received from the reference unit 215. For example, the correction selecting unit 218 calculates a center of gravity G _{M} of the person M on the basis of the extracted outlines.

For example, on the basis of the IR image received from the image correction unit 213, the correction selecting unit 218 assumes a region, in which a light quantity is saturated, as the sun S and extracts an outline thereof. For example, the correction selecting unit 218 calculates a center of gravity G_{S} of the sun S on the basis of the extracted outline.

The correction selecting unit 218 draws a straight line L1 connecting the center of gravity G_{M} and the center of gravity G_{S}. The correction selecting unit 218 draws an orthogonal line O that passes through the center of gravity G_{S} and that is orthogonal to the straight line L. For example, the correction selecting unit 218 draws N straight lines (N is an integer equal to or larger than 2) such as a straight line L2 and a straight line L3 drawn from the straight line L1 toward the person M at an angle θ with the center of gravity G_{S} as an origin within a range of ±90 degrees from the straight line L1.

The correction selecting unit 218 extracts contact points between the straight lines drawn toward the person M and the outline of the person M. For example, the correction selecting unit 218 extracts a contact point I1 between the straight line L1 and the outline of the person M, a contact point I2 between the straight line L2 and the outline of the person M, and a contact point I3 between the straight line L3 and the outline of the person M.

The correction selecting unit 218 calculates a distance from the center of gravity G_{S} to the outline of the person. For example, the correction selecting unit 218 calculates a distance from the center of gravity G_{S} to the contact point I1. For example, the correction selecting unit 218 calculates a distance from the center of gravity G_{S} to the contact point I2. For example, the correction selecting unit 218 calculates a distance from the center of gravity G_{S} to the contact point I3. The correction selecting unit 218 sets the shortest one among the calculated distances as the shortest distance. In the example illustrated in FIG. 11, the correction selecting unit 218 sets the distance from the center of gravity G_{S} to the contact point I1 as the shortest distance.

For example, when the shortest distance is equal to or shorter than a predetermined value set in advance, the correction selecting unit 218 determines that the sun is close, and selects a correction using a light-source-off image. For example, in a case where the shortest distance exceeds the predetermined value set in advance or it is determined that there is no sun, the correction selecting unit 218 selects a correction using a dark image stored in advance in a storage unit 230.

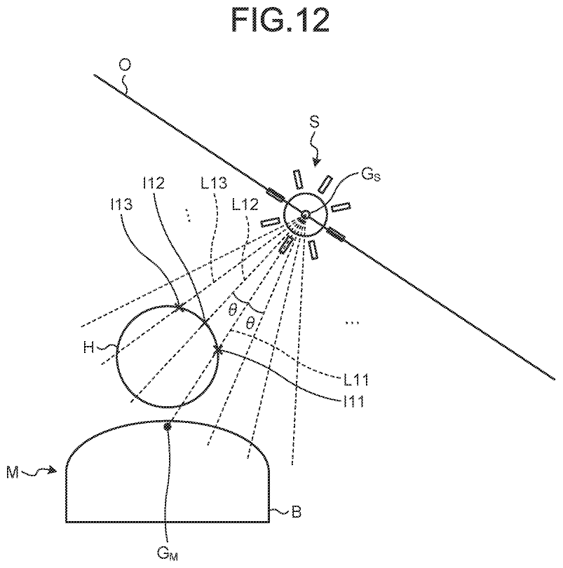

Note that, as illustrated in FIG. 12, even in a case where the sun S is located in oblique information of the person M, the correction selecting unit 218 can select a correction by a method similar to the method illustrated in FIG. 11. Specifically, the correction selecting unit 218 may draw a straight line L11 connecting the center of gravity G_{S} and the center of gravity G_{M}, and draw a plurality of straight lines such as a straight line L12 and a straight line L13 inclined at an angle θ from the straight line within a range of ±90 degrees. In this case, the correction selecting unit 218 may extract a contact point I11 between the straight line L11 and the outline of the person M, a contact point I12 between the straight line L12 and the outline of the person M, and a contact point I13 between the straight line L13 and the outline of the person M, and calculate a distance of each thereof. Then, the correction selecting unit 218 may set the shortest one among the calculated distances as the shortest distance.

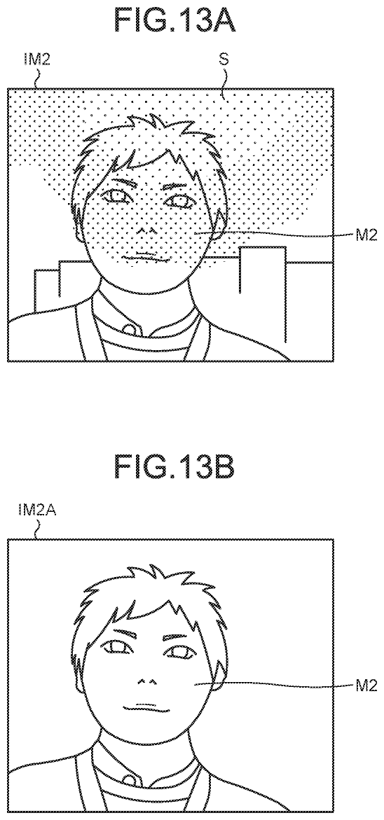

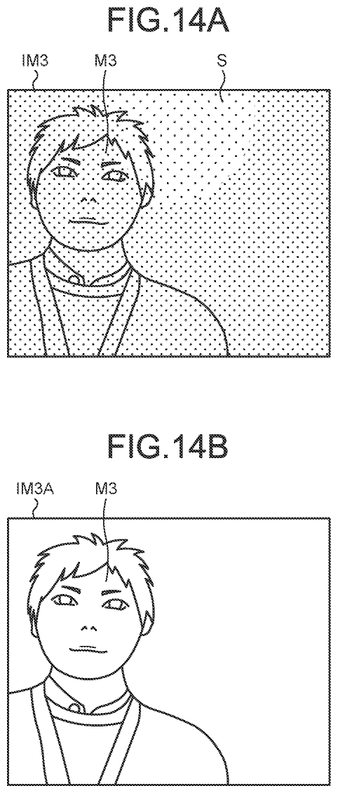

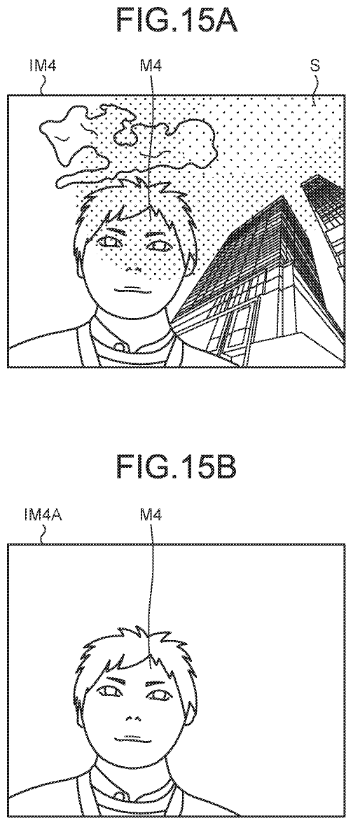

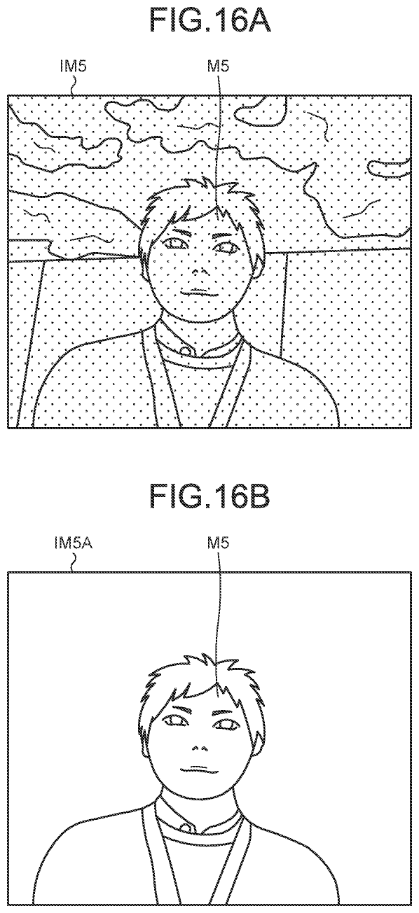

Effects of corrections selected by the correction selecting method according to the second embodiment of the present disclosure will be described with reference to FIG. 13A, FIG. 13B, FIG. 14A, FIG. 14B, FIG. 15A, FIG. 15B, FIG. 16A, and FIG. 16B. FIG. 13A to FIG. 16B are views for describing the effects of the corrections selected by the correction selecting method according to the second embodiment of the present disclosure.

An IR image IM2 illustrated in FIG. 13A is an IR image before correction in which image the sun S is located at a relatively close position directly above a head of a person M2. In the IR image IM2, it is difficult to recognize a face of the person M2 due to an influence of sunlight of the sun S. In a case of correcting such an IR image IM2, the correction selecting unit 218 selects a correction using a light-source-off image.

An IR image IM2A illustrated in FIG. 13B is an IR image acquired by execution of the correction on the IR image IM2 on the basis of the light-source-off image. In the IR image IM2A, the influence of the sunlight is removed by the correction based on the light-source-off image. Thus, the face of the person M2 can be clearly recognized in the IR image IM2A. As a result, a recognition rate in face authentication of the person M2 is improved.

An IR image IM3 illustrated in FIG. 14A is an IR image before correction in which image the sun S is located at a relatively close position obliquely above a head of a person M3. In the IR image IM3, it is difficult to recognize a face of the person M3 due to an influence of sunlight of the sun S. In a case of correcting such an IR image IM3, the correction selecting unit 218 selects a correction using a light-source-off image.

An IR image IM3A illustrated in FIG. 14B is an IR image acquired by execution of the correction on the IR image IM3 on the basis of the light-source-off image. In the IR image IM3A, the influence of the sunlight is removed by the correction based on the light-source-off image. Thus, the face of the person M3 can be clearly recognized in the IR image IM3A. As a result, a recognition rate in face authentication of the person M3 is improved.

An IR image IM4 illustrated in FIG. 15A is an IR image before correction in which image the sun S is located at a relatively far position obliquely above a head of a person M4. In the IR image IM4, a face of the person M4 is relatively easily recognized since the sun S is located at the relatively far position. In a case of correcting such an IR image IM4, the correction selecting unit 218 selects a correction using a dark image.

An IR image IM4A illustrated in FIG. 15B is an IR image acquired by execution of the correction on the IR image IM4 on the basis of the dark image. In the IR image IM4A, the face of the person M4 can be more clearly recognized since an influence of a background is removed by the correction based on the dark image. As a result, a recognition rate in face authentication of the person M4 is improved.

An IR image IM5 illustrated in FIG. 16A is an IR image before correction in which image the sun is not included. In the IR image IM4, a face of a person M5 is relatively easily recognized since the sun is not included. In a case of correcting such an IR image IM5, the correction selecting unit 218 selects a correction using a dark image.

An IR image IM5A illustrated in FIG. 16B is an IR image acquired by execution of the correction on the IR image IM5 on the basis of the dark image. In the IR image IM5A, the face of the person M4 can be more clearly recognized since an influence of a background is removed by the correction based on the dark image. As a result, a recognition rate in face authentication of the person M5 is improved.

(3-3. Processing of Correction Selecting Method)

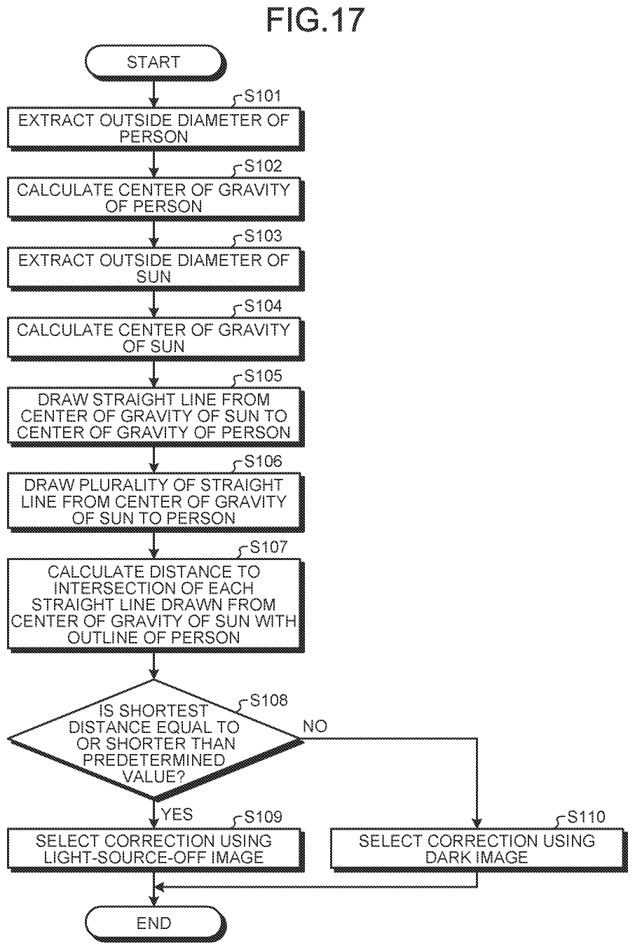

A flow of the processing of the correction selecting method according to the second embodiment of the present disclosure will be described with reference to FIG. 17. FIG. 17 is a flowchart illustrating an example of the flow of the processing of the correction selecting method according to the second embodiment of the present disclosure.

First, on the basis of information related to depth, the correction selecting unit 218 extracts an outline of a person included in an IR image to be corrected (Step S101). Then, the processing proceeds to Step S102.

The correction selecting unit 218 calculates a center of gravity of the person on the basis of the outline of the person which outline is extracted in Step S101 (Step S102). Then, the processing proceeds to Step S103.

The correction selecting unit 218 extracts an outline of the sun on the basis of a region with a saturated light quantity in the IR image to be corrected (Step S103). Then, the processing proceeds to Step S104.

The correction selecting unit 218 calculates a center of gravity of the sun on the basis of the outline of the sun which outline is extracted in Step S103 (Step S104). Then, the processing proceeds to Step S105.

The correction selecting unit 218 draws a straight line connecting the center of gravity of the person which center of gravity is calculated in Step S102 and the center of gravity of the sun which center of gravity is calculated in Step S104 (Step S105). Then, the processing proceeds to Step S106.

The correction selecting unit 218 draws a plurality of straight lines to the person from the center of gravity of the sun (Step S106). Specifically, the correction selecting unit 218 draws a plurality of straight lines within a range of ±90 degrees from the center of gravity of the sun to the straight line drawn in Step S105. Then, the processing proceeds to Step S107.

The correction selecting unit 218 calculates a distance to an intersection of each of the straight lines drawn from the center of gravity of the sun in Step S106 with the outline of the person (Step S107). Then, the processing proceeds to Step S108.

The correction selecting unit 218 determines whether the shortest distance of the straight lines drawn from the center of gravity of the sun to the outline of the person is equal to or shorter than a predetermined value (Step S108). In a case where it is determined that the shortest distance is equal to or shorter than the predetermined value (Yes in Step S108), the processing proceeds to Step S109. In a case where it is determined that the shortest distance is not equal to or shorter than the predetermined value (No in Step S108), the processing proceeds to Step S110.

In a case where it is determined as Yes in Step S108, the correction selecting unit 218 selects a correction using a light-source-off image (Step S109). Then, the processing of FIG. 17 is ended.

On the other hand, in a case where it is determined as No in Step S108, the correction selecting unit 218 selects a correction using a dark image (Step S110). Then, the processing of FIG. 17 is ended.

As described above, in the second embodiment, a correction for an IR image can be appropriately selected according to a distance between a person and the sun. Thus, a recognition rate of face authentication or the like can be improved.

### 4. Modification Example of Second Embodiment

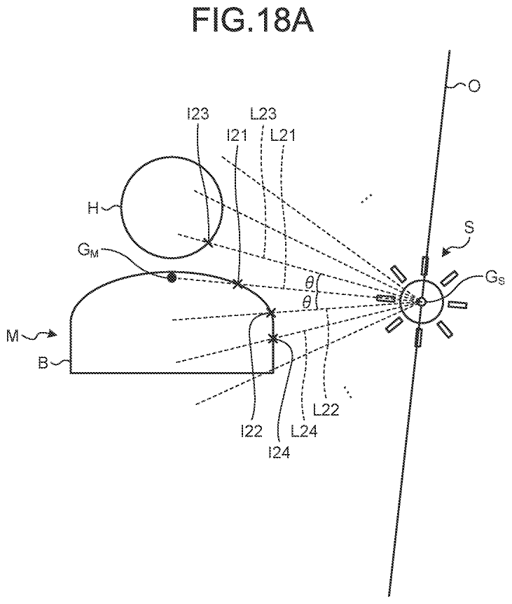

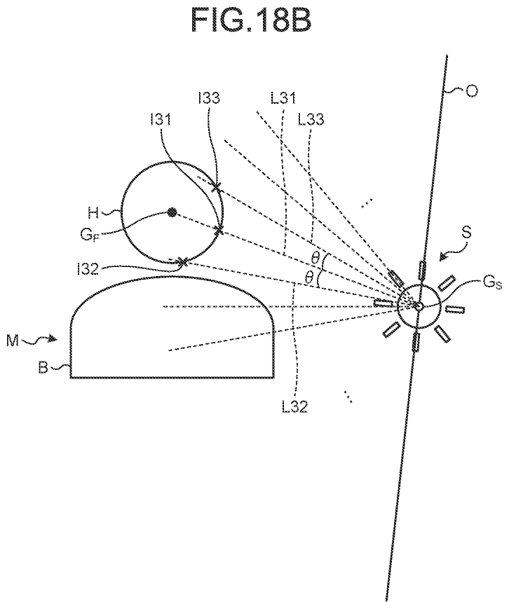

A modification example of the second embodiment of the present disclosure will be described with reference to FIG. 18A and FIG. 18B. FIG. 18A and FIG. 18B are views for describing the modification example of the second embodiment of the present disclosure.

As described above, in the second embodiment, a correction method is selected on the basis of the shortest distance from a center of gravity of the sun to an outline of a person. For example, since information necessary in face authentication is face information, a correction method may be selected on the basis of the shortest distance from a center of gravity of the sun to an outline of a face of a person in a modification example of the second embodiment.

As illustrated in FIG. 18A, a situation in which the sun S is on a side of a person M is considered. In this case, the correction selecting unit 218 draws a straight line L21 from a center of gravity G_{S} of the sun to a center of gravity G_{M} of the person M. Then, the correction selecting unit 218 draws a plurality of straight lines such as a straight line L22, a straight line L23, and a straight line L24 from the center of gravity G_{S} toward an outline of the person M. Then, the correction selecting unit 218 extracts a contact point I21 between the straight line L21 and the outline of the person M, a contact point I22 between the straight line L22 and the outline of the person M, a contact point I23 between the straight line L23 and the outline of the person M, and a contact point I24 between the straight line L24 and the outline of the person M. In this case, the correction selecting unit 218 determines a distance from the center of gravity G_{S} of the sun to the contact point I22 as the shortest distance. Since the center of gravity G_{S} of the sun is relatively close to the contact point I22, the correction selecting unit 218 selects a correction using a light-source-off image. However, since a distance from a center of gravity GS of the sun to a face of the person M (distance from the center of gravity G_{S} of the sun to the contact point I23) is relatively long, there is a possibility that desired recognition accuracy cannot be acquired by the correction using the light-source-off image when the face authentication is performed.

As illustrated in FIG. 18B, the correction selecting unit 218 calculates a center of gravity G_{F} of the face of the person M in the modification example of the second embodiment. Specifically, the correction selecting unit 218 extracts the outline of the person M on the basis of information related to depth, and calculates the center of gravity G_{F} of the face of the person M.

In the example illustrated in FIG. 18B, the correction selecting unit 218 draws a straight line L31 from the center of gravity G_{S} of the sun to the center of gravity G_{F} of the face of the person M. Then, the correction selecting unit 218 draws a plurality of straight lines such as a straight line L32 and a straight line L33 from the center of gravity G_{S} toward an outline of the face of the person M. Then, the correction selecting unit 218 extracts a contact point I31 between the straight line L31 and the outline of the face of the person M, a contact point I32 between the straight line L32 and the outline of the face of the person M, and a contact point I33 between the straight line L33 and the outline of the person M. In this case, the correction selecting unit 218 determines a distance from the center of gravity G_{S} of the sun to the contact point I31 as the shortest distance. Since the center of gravity G_{S} of the sun is relatively far from the contact point I31, the correction selecting unit 218 selects a correction using a dark image. As a result, it is possible to improve a recognition rate of when the face authentication is performed.

As described above, in the modification example of the second embodiment, a correction for an IR image can be appropriately selected according to a distance from a face of a person to the sun. Thus, the recognition rate of the face authentication or the like can be further improved.

(Effect)

An image processing device 20 according to an aspect of the present disclosure includes an IR image generation unit 212 that generates, in an IR image frame, a first IR image captured in a state in which a pulse wave is on and a second IR image captured in a state in which the pulse wave is off, and an image correction unit 213 that corrects the first IR image on the basis of the second IR image.

Thus, the IR image captured in a state in which the pulse wave is on can be corrected on the basis of the IR image captured in a state in which the pulse wave is off. As a result, it is possible to remove an influence of strong light such as the sun and to improve a recognition rate.

Also, the IR image frame may include a phase of generating the first IR image and a phase of generating the second IR image.

Thus, an IR image in a state in which the pulse wave is on and an IR image in a state in which the pulse wave is off can be generated in one microframe.

Also, the image correction unit 213 may remove, on the basis of the second IR image, background light and a dark component included in the first IR image.

Thus, only a component of reflected light can be extracted.

Also, the image correction unit 213 may individually adjust exposure time of a TOF sensor in each frame.

Thus, the exposure time in each piece of processing can be appropriately adjusted.

Also, the image correction unit 213 may individually adjust the exposure time of the TOF sensor in each of the IR image frame and a depth image frame.

Thus, an IR image and a depth image can be appropriately generated.

Also, the image correction unit 213 may control the exposure time in a phase included in the IR image frame to be longer than the exposure time in a phase included in the depth image frame.

Thus, an IR image and a depth image can be appropriately generated, and power consumption can be controlled.

Also, the image correction unit 213 may individually adjust the exposure time of the TOF sensor in each of the IR image frame, the depth image frame, and an eye-gaze detection frame.

Thus, an IR image and a depth image can be appropriately generated, and an eye-gaze can be appropriately detected.

Also, the image correction unit 213 may perform control in such a manner that the exposure time in a phase included in the IR image frame, the exposure time in a phase included in the eye-gaze detection frame, and the exposure time in a phase included in the depth image frame are lengthened in this order.

Thus, an IR image and a depth image can be generated more appropriately, and an eye-gaze can be detected more appropriately. In addition, power consumption can be controlled.

A correction selecting unit 218 that selects a correction method according to a positional relationship between a subject included in the first IR image and a light source may be further included.

Thus, it is possible to select an appropriate correction method according to the positional relationship between the subject and the light source and to improve recognition accuracy.

The correction selecting unit 218 may select the correction method according to a distance between the subject and the light source.

Thus, it is possible to select the correction method more according to the distance between the subject and the light source and to further improve the recognition accuracy.

The correction selecting unit 218 may select, for the first IR image, either a correction based on the second IR image or a correction based on a dark image stored in advance in a storage unit 230 according to the distance between the subject and the light source.

Thus, it is possible to select a more appropriate correction method according to the distance between the subject and the light source and to further improve the recognition accuracy.

For the first IR image, the correction selecting unit 218 may select the correction based on the second IR image in a case where the distance between the subject and the light source is equal to or shorter than a threshold, and may select the correction based on the dark image in a case where the distance between the subject and the light source exceeds the threshold.

As a result, the recognition accuracy is improved since a more appropriate legal method can be selected according to whether the distance between the subject and the light source exceeds the threshold.

The subject may be a face of a person and the light source may be the sun.

Thus, it is possible to improve accuracy of face authentication in the outside where an influence of sunlight is strong.

Electronic equipment 1 of an aspect of the present disclosure includes a TOF sensor, an IR image generation unit 212 that generates a first IR image captured in a state in which a pulse wave is on and a second IR image captured in a state in which the pulse wave is off in an IR image frame on the basis of an output from the TOF sensor, and an image correction unit 213 that corrects the first IR image on the basis of the second IR image.

Thus, the IR image captured in a state in which the pulse wave is on can be corrected on the basis of the IR image captured in a state in which the pulse wave is off. As a result, it is possible to remove an influence of strong light such as the sun and to improve a recognition rate.

In an image processing method of an aspect of the present disclosure, a first IR image captured in a state in which a pulse wave is on and a second IR image captured in a state in which the pulse wave is off are generated in an IR image frame, and the first IR image is corrected on the basis of the second IR image.

Thus, the IR image captured in a state in which the pulse wave is on can be corrected on the basis of the IR image captured in a state in which the pulse wave is off. As a result, it is possible to remove an influence of strong light such as the sun and to improve a recognition rate.

A program of an aspect of the present disclosure causes a computer to function as an image generation unit that generates, in an IR image frame, a first IR image captured in a state in which a pulse wave is on and a second IR image captured in a state in which the pulse wave is off, and an image correction unit that corrects the first IR image on the basis of the second IR image.

Thus, the IR image captured in a state in which the pulse wave is on can be corrected on the basis of the IR image captured in a state in which the pulse wave is off. As a result, it is possible to remove an influence of strong light such as the sun and to improve a recognition rate.

Note that the effects described in the present description are merely examples and are not limitations, and there may be a different effect.

Note that the present technology can also have the following configurations.
(1)

An image processing device comprising:

an image generation unit that generates, in an IR image frame, a first IR image captured in a state in which a pulse wave is on and a second IR image captured in a state in which the pulse wave is off; and

an image correction unit that corrects the first IR image on a basis of the second IR image.
(2)

The image processing device according to (1), wherein

the IR image frame includes a phase of generating the first IR image and a phase of generating the second IR image.
(3)

The image processing device according to (1) or (2), wherein

the image correction unit removes background light and a dark component included in the first IR image on a basis of the second IR image.
(4)

The image processing device according to any one of (1) to (3), wherein

the image correction unit individually adjusts exposure time of a TOF sensor in each frame.
(5)

The image processing device according to (4), wherein

the image correction unit individually adjusts the exposure time of the TOF sensor in each of the IR image frame and a depth image frame.
(6)

The image processing device according to (5), wherein

the image correction unit controls the exposure time in a phase included in the IR image frame to be longer than the exposure time in a phase included in the depth image frame.
(7)

The image processing device according to (4), wherein

the image correction unit individually adjusts the exposure time of the TOF sensor in each of the IR image frame, a depth image frame, and an eye-gaze detection frame.
(8)

The image processing device according to (7), wherein

the image correction unit performs control in such a manner that the exposure time in a phase included in the IR image frame, the exposure time in a phase included in the eye-gaze detection frame, and the exposure time in a phase included the depth image frame are lengthened in this order.
(9)

The image processing device according to any one of (1) to (8), further comprising

a correction selecting unit that selects a correction method according to a positional relationship between a subject included in the first IR image and a light source.
(10)

The image processing device according to (9), wherein

the correction selecting unit selects the correction method according to a distance between the subject and the light source.
(11)

The image processing device according to (9) or (10), wherein

the correction selecting unit selects, for the first IR image, either a correction based on the second IR image or a correction based on a dark image stored in advance in a storage unit according to the distance between the subject and the light source.
(12)

The image processing device according to any one of (9) to (11), wherein

the correction selecting unit selects, for the first IR image, the correction based on the second IR image in a case where the distance between the subject and the light source is equal to or shorter than a threshold, and selects the correction based on the dark image in a case where the distance between the subject and the light source exceeds the threshold.
(13)

The image processing device according to any one of (9) to (12), wherein

the subject is a face of a person, and

the light source is sun.
(14)

Electronic equipment comprising:

a TOF sensor;

an image generation unit that generates, on a basis of an output from the TOF sensor, a first IR image captured in a state in which a pulse wave is on and a second IR image captured in a state in which the pulse wave is off in an IR image frame; and

an image correction unit that corrects the first IR image on a basis of the second IR image.
(15)

An image processing method comprising:

generating, in an IR image frame, a first IR image captured in a state in which a pulse wave is on and a second IR image captured in a state in which the pulse wave is off; and

correcting the first IR image on a basis of the second IR image.
(16)

A program causing

a computer to function as

an image generation unit that generates, in an IR image frame, a first IR image captured in a state in which a pulse wave is on and a second IR image captured in a state in which the pulse wave is off, and

an image correction unit that corrects the first IR image on a basis of the second IR image.

### REFERENCE SIGNS LIST

1 ELECTRONIC EQUIPMENT

10 IMAGING DEVICE

11 LIGHT SOURCE UNIT

12 LIGHT RECEIVING UNIT

13 IMAGING PROCESSING UNIT

20 IMAGE PROCESSING DEVICE

30 EMISSION LIGHT

31 OBJECT

32 REFLECTED LIGHT

210 IR IMAGE PROCESSING DEVICE

211, 221 ACQUISITION UNIT

212 IR IMAGE GENERATION UNIT

213 IMAGE CORRECTION UNIT

214 NORMALIZATION UNIT

215 REFERENCE UNIT

216 FIRST EXPOSURE TIME CALCULATION UNIT

217 SECOND EXPOSURE TIME CALCULATION UNIT

218 CORRECTION SELECTING UNIT

220 DEPTH IMAGE PROCESSING DEVICE

222 DEPTH CALCULATION UNIT

230 STORAGE UNIT

1. An image processing device comprising:
an image generation unit that generates, in an IR image frame, a first IR image captured in a state in which a pulse wave is on and a second IR image captured in a state in which the pulse wave is off; and
an image correction unit that corrects the first IR image on a basis of the second IR image.

2. The image processing device according to claim 1, wherein
the IR image frame includes a phase of generating the first IR image and a phase of generating the second IR image.

3. The image processing device according to claim 1, wherein
the image correction unit removes background light and a dark component included in the first IR image on a basis of the second IR image.

4. The image processing device according to claim 1, wherein
the image correction unit individually adjusts exposure time of a TOF sensor in each frame.

5. The image processing device according to claim 4, wherein
the image correction unit individually adjusts the exposure time of the TOF sensor in each of the IR image frame and a depth image frame.

6. The image processing device according to claim 5, wherein
the image correction unit controls the exposure time in a phase included in the IR image frame to be longer than the exposure time in a phase included in the depth image frame.

7. The image processing device according to claim 4, wherein
the image correction unit individually adjusts the exposure time of the TOF sensor in each of the IR image frame, a depth image frame, and an eye-gaze detection frame.

8. The image processing device according to claim 7, wherein
the image correction unit performs control in such a manner that the exposure time in a phase included in the IR image frame, the exposure time in a phase included in the eye-gaze detection frame, and the exposure time in a phase included the depth image frame are lengthened in this order.

9. The image processing device according to claim 1, further comprising
a correction selecting unit that selects a correction method according to a positional relationship between a subject included in the first IR image and a light source.

10. The image processing device according to claim 9, wherein
the correction selecting unit selects the correction method according to a distance between the subject and the light source.

11. The image processing device according to claim 10, wherein
the correction selecting unit selects, for the first IR image, either a correction based on the second IR image or a correction based on a dark image stored in advance in a storage unit according to the distance between the subject and the light source.

12. The image processing device according to claim 11, wherein
the correction selecting unit selects, for the first IR image, the correction based on the second IR image in a case where the distance between the subject and the light source is equal to or shorter than a threshold, and selects the correction based on the dark image in a case where the distance between the subject and the light source exceeds the threshold.

13. The image processing device according to claim 12, wherein
the subject is a face of a person, and
the light source is sun.

14. Electronic equipment comprising:
a TOF sensor;
an image generation unit that generates, on a basis of an output from the TOF sensor, a first IR image captured in a state in which a pulse wave is on and a second IR image captured in a state in which the pulse wave is off in an IR image frame; and
an image correction unit that corrects the first IR image on a basis of the second IR image.

15. An image processing method comprising:
generating, in an IR image frame, a first IR image captured in a state in which a pulse wave is on and a second IR image captured in a state in which the pulse wave is off; and
correcting the first IR image on a basis of the second IR image.

16. A program causing
a computer to function as
an image generation unit that generates, in an IR image frame, a first IR image captured in a state in which a pulse wave is on and a second IR image captured in a state in which the pulse wave is off, and
an image correction unit that corrects the first IR image on a basis of the second IR image.
